(19) United States
(12) Patent Application Publication
(10) Pub. No.: US 2002/0004130 A1
(43) Pub. Date: Jan. 10, 2002

(54) Acrylic foam-like tape

(76) Inventor: Ramesh Lhila, South Windsor, CT (US)

Correspondence Address: McCormick, Paulding & Huber, City Place II, 185 Asylum Street, Hartford, CT, 06103-3402, US

(21) Appl. No.: 09/898,969

(22) Filed: Jul. 3, 2001

Related U.S. Application Data
(60) Provisional application No. 60/216,733, filed on Jul. 7, 2000.

(51) Int. Cl. B32B 7/12

(52) U.S. Cl. 428/317.1; 428/317.7

(57) ABSTRACT

Pressure-sensitive adhesive tape has a backing comprising 88-92% acrylic polymer containing: 35-45% of a first alkyl acrylate monomer wherein the alkyl groups contain 4 to 12 carbon atoms, 30-40% of a second alkyl acrylate monomer wherein the alkyl groups contain 4 to 12 carbon atoms, 6-10% a first monoethylenically unsaturated polar copolymerizable monomer, 1-2% a second monoethylenically unsaturated polar copolymerizable monomer, 0.3-0.5% photoinitiator, 1-2% filler, 0.05-0.07% crosslinker/chain extender, and 8-12% hollow glass microspheres dispersed evenly in the polymer; and a pressure-sensitive adhesive layer on at least one side of the backing. A method for preparing the adhesive tape involves partially polymerizing an oligomer, forming a coating composition, coating the composition onto a first liner with a second liner contiguously covering the first liner, and polymerizing the composition on the liners between two banks of ultraviolet light while cooling to form a foam-like sheet useful as a tape backing.

### CROSS REFERENCE TO RELATED APPLICATION

This application claims the benefit of U.S. Provisional Application Ser. No. 60/216,733, filed on Jul. 7, 2000.

### BACKGROUND OF THE INVENTION

The present invention relates to acrylic pressure sensitive adhesive tape products. In particular, the present invention relates to a pressure-sensitive adhesive tape having a compressible acrylic foam-like backing layer with hollow glass microspheres dispersed evenly throughout the backing, and to a method for making the pressure-sensitive adhesive tape.

Compressible pressure-sensitive adhesive tapes are widely used. Historically, such tapes have foam backing which may have a pressure-sensitive adhesive applied to one side, or to both sides. When the adhesive layer is applied to both sides of the backing, the adhesive layer may be the same on both or different. Different adhesives are used to facilitate adhesion between different types of surfaces. Foam backed pressure-sensitive adhesive tapes with two adhesive sides have been used to mount objects such as pictures on walls and molding to the metal frame of automobiles. Single-sided pressure-sensitive adhesive foam tapes may be used to provide a cushion between two objects. Furthermore, compressible tapes are especially useful for adhesion to uneven or irregular surfaces. Recovering from compression is desirable for compressible tapes. Most foam tapes are compressible but do not recover substantially from compression over time.

The majority of compressible pressure-sensitive adhesive tapes have backings with open cell structures. U.S. Pat. No. 3,993,833 issued to Esmay on Nov. 23, 1976 describes a foam-backed pressure-sensitive adhesive tape having an open-cell polyurethane foam backing capable of having adhesive applied thereto. U.S. Pat. No. 4,484,574 issued to DeRusha et al. on Nov. 27, 1984 discloses a pressure-sensitive tape having a closed-cell polymer foam backing strip and a pressure-sensitive adhesive, which may be acrylic, applied thereto. U.S. Pat. No. 5,334,447 issued to Kitamura et al. on Aug. 2, 1994 shows a foam substrate-attached adhesive sheet having a foam elastomer with a pressure-sensitive adhesive layer thereon; the foam elastomer contains a foaming agent to impart voids therein. Canadian Patent No. 747,341 discloses a double-coated polyurethane foam-layer pressure-sensitive adhesive mounting tape for mounting objects to walls and the like. All of these pressure-sensitive adhesive products have voids dispersed within the backing and are compressible.

More recently, compressible pressure-sensitive adhesive tapes have been made with voids and/or microbubbles in the adhesive layer. It is known to make acrylic pressure-sensitive adhesives filled with glass microbubbles resulting in the adhesive layer having a foam-like appearance and character. U.S. Pat. No. 3,314,838 issued to J. V. Erwin on Apr. 18, 1967 is the first example of hollow spheroidal particles in pressure-sensitive adhesives. Such foam-like adhesives have been used in place of the traditional foam backings but lack their durability. Prior art pressure sensitive adhesive tapes have not had microbubbles dispersed in the backing layer.

U.S. Pat. No. 4,223,067 issued to Levens on Sep. 16, 1980 discloses a foam-like pressure-sensitive adhesive tape having a pressure sensitive adhesive layer which is a void-free flowable polymer matrix containing glass microbubbles, has the appearance of foam-backed tape, and is composed primarily of monomers of isooctylacrylate and acrylic acid. The thickness of the adhesive layer relative to the microbubbles should be sufficient to permit the microbubbles to migrate within the adhesive allowing the adhesive to flow when applied to an uneven surface. Obviously, a flowable adhesive layer does not have the strength of a foam backed tape but provides a greater surface area for adhesion as it conforms more completely to an uneven surface.

U.S. Pat. No. 4,415,615 issued to Esmay et al. on Nov. 15, 1983 discloses an adhesive layer made by frothing an inert gas into an acrylate monomer mixture composition which is photopolymerizable to a pressure-sensitive adhesive state, coating the froth onto a backing, and photopolymerizing to form a pressure-sensitive adhesive having a cellular structure. Thermal polymerization may be substituted for photopolymerization. The cellular adhesive layer of the Esmay tape comprises at least 15% to 85% voids by volume, excluding the voids found within microbubbles. A thixotropic agent, such as fumed silica, may be mixed with the monomers permitting the entire polymerization in a single step following coating the monomers onto a substrate. The action of frothing the acrylic polymer matrix reduces the internal strength of these cellular pressure-sensitive adhesive membranes relative to nonfrothed samples, and to adhesives applied to foam backed tapes.

U.S. Pat. No. 4,303,485 issued to Levens on Dec. 1, 1981 describes glass microbubbles having an average diameter of 10 to 200 micrometers mixed with an acrylate, an oxidizable tin salt and a photointiator, and polymerized into a pressure-sensitive adhesive state; the tin salt allows photopolymerization of thick layers of the mixture in air. Likewise, U.S. Pat. Nos. 5,883,149 and 5,683,798, issued to Bennett et al. on Mar. 16, 1999 and Nov. 4, 1997 respectively, disclose tackified pressure sensitive adhesives which may include microspheres in the adhesives creating a foam-like appearance. The resulting polymerized adhesives have foam-like appearances, and are used in the same manner as conventional foam-backed pressure-sensitive adhesive tapes but lack the strength thereof.

U.S. Pat. No. 5,612,136 issued to Everaerts et al. on Mar. 18, 1997 describes pressure-sensitive adhesives having improved adhesion to acid-rain resistant automotive paints wherein the adhesives are applied either to a backing or to a core layer of a second adhesive. For example, separate embodiments disclosed in Everaerts et al. utilize the pressure-sensitive adhesive layers disclosed in either U.S. Pat. No. 4,223,067 or 4,415,615 (discussed infra) as the core layer thus forming two adhesive layers having foam-like appearances. The two adhesive layers are heat laminated together to form a foam-like adhesive tape having release liners on both exterior surfaces.

Furthermore, it is known to have glass microbubbles in pigmented adhesives either by including a pigment in the monomer mixture or by utilizing pigmented, or stained, glass microbubbles. European Patent Application No. 0 324 242 A2 discloses a foam-like pressure-sensitive adhesive tape wherein at least one layer of the pressure-sensitive adhesive has pigment-coated microbubbles dispersed therein. U.S. Pat. No. 4,780,491 issued to Vesley et al. on Oct. 25, 1988 discloses a pressure-sensitive tape having stained glass microbubbles dispersed in the adhesive layer and a pigment or dye dispersed throughout the adhesive layer; each stained glass microbubble has an ultraviolet window permitting photopolymerization. U.S. Pat. No. 4,895,745 issued to Vesley et al. on Jan. 23, 1990 discloses a pressure sensitive adhesive tape produced by photopolymerization which has a pressure-sensitive adhesive layer, containing microbubbles, wherein the adhesive layer has a dark appearance because a pigment or dye plus a finely divided hydrophobic silica is mixed therein.

U.S. Pat. No. 5,024,880 issued to Veasley et al. on Jun. 18, 1991 describes phase-separated, polymerized, cellular pressure-sensitive adhesive membranes containing acrylic polymer with an alkyl acrylate monomer, a monoethylenically unsaturated polar copolymerizable monomer, a surfactant, a photoinitiator, and a saturated hydrocarbon elastomer or blend thereof. The membrane has a multiplicity of small voids constituting from 15% to 85% of the volume of the membrane, and may have microbubbles, which are preferably not glass microbubbles. The membranes are created by frothing a surfactant containing composition which is polymerizable to a pressure-sensitive adhesive state, coating the froth onto a backing, and polymerizing in situ. The acrylic copolymer phase forms a continuous phase while the elastomer phase is present in an interconnected network.

Four methods are primarily used for the production of acrylic-based pressure-sensitive adhesive tapes. The four methods include solution polymerization, emulsion polymerization, irradiation by high energy particulate matter (e.g., electron beams or gamma rays), and ultraviolet light photopolymerization. Each of these methods has advantages and disadvantages.

Solution polymerization has the disadvantage of requiring elaborate drying ovens with substantial exhaust ducts and high temperatures to carry away the volatile solvents after coating. Extensive solvent recovery systems are required to minimize pollution and solvent loss. The solvents are extremely flammable requiring safety precautions to avoid explosions throughout the production of the pressure-sensitive adhesive tapes. Additionally, workers must avoid exposure to solvent fumes because of potential health hazards. Solution polymerization has the added limitation that the thickness of the coatings which can be deposited in one trip or pass through the coater. Coatings exceeding about 5 mils require multiple coating layers to avoid blistering of the coating due to solvent evaporation. Solution polymerization is still useful for application of thin layers of adhesive to a backing.

Although emulsion polymerization eliminates the problems associated with the use of flammable solvents, the heat of vaporization must be supplied to remove the water from the coating thus requiring the same type equipment as in solution polymerization. Higher solids coatings are possible however the higher heat of vaporization of water as compared to organic solvents offsets this benefit and about the same total energy for drying is necessitated. Since the drying times are relatively long, production is limited. Furthermore, the emulsifying agent utilized in emulsion polymerization remains in the final polymer and results in water sensitive pressure-sensitive adhesive tapes. Additionally, the highly polar water miscible monomers tend to homopolymerize in the aqueous phase and are difficult to incorporate into the copolymer during polymerization.

Polymerization by high energy particulate matter, such as electron beams, have the disadvantage of an indiscriminate polymerization process. In polymerization processes utilizing an electron beam, the particle bombardment of the free-radically polymerizable monomers cannot be precisely controlled, resulting in chain scission of the developing polymer and an inability to control its molecular weight and crosslink density to the most desired range.

Frequently, a one step or stage low-intensity ultraviolet photopolymerization process is utilized in the manufacture of pressure-sensitive adhesives and tapes. Intensity and spectral distribution of the irradiation are controlled in order to attain desirable cohesive strengths and peel resistance. For example, U.S. Pat. No. 4,181,752 issued to Martens et al. on Jan. 1, 1980 describes a process for the preparation of acrylate copolymer pressure-sensitive adhesive, and tapes comprising the adhesives, which utilizes low intensity ultraviolet radiation curing to polymerize the monomers in the adhesive. The process of Martens et al. requires a closed off, completely inert atmosphere.

U.S. Pat. No. 5,183,833 issued to Fisher et al. on Feb. 2, 1993, and European Patent Application 0 426 198 A2, disclose a process for the ultraviolet radiation photopolymerization of acrylic ester pressure sensitive adhesive formulations wherein a source of ultraviolet radiation provides a substantial portion of its ultraviolet radiation in the wavelength band of from about 280 to about 350 nm and a light intensity at the surface of the formulation being polymerized of no more than about 4.0 miliwatts/cm². Also, U.S. Pat. No. 4,968,558 issued to Fisher et al. on Nov. 6, 1990 describes a process for the ultraviolet radiation photopolymerization of acrylic ester pressure-sensitive adhesive formulations which involves partially photopolymerizing sequentially a plurality of layers of acrylic ester pressure-sensitive adhesive formulation, wherein at least one of the layers is exposed to ultraviolet radiation, as in U.S. Pat. No. 5,183,833 (discussed infra), while overlying a second layer that has been previously subjected to the same ultraviolet radiation.

The use of relatively low intensity ultraviolet light is desirable for building higher molecular weight acrylic pressure-sensitive adhesives and tapes with good performance properties, however, an increase in the speed of the photopolymerization process is desirable. Attempts to increase the speed of the low intensity ultraviolet light-based processes, by increasing the amount of photoinitiator utilized, result in undesirable lower molecular weight polymers. Also, for thicker layers of polymer, an uneven polymerization from the front surface to the back surface of an irradiated polymer layer occurs due to the uneven light absorption by the photopolymerization initiator resulting in a differential performance of the final pressure sensitive adhesive product.

Multi-stage polymerization processes have also been utilized. Two stage photopolymerization processes are known wherein the first stage involves relatively low intensity ultraviolet light and the second stage involves higher intensity ultraviolet light. At least 75%, up to 90% or higher, of the vinyl group monomer is reacted in the first stage. In contrast, the PCT Application No. WO 92/15394 discloses a multi-stage irradiation process for the production of acrylic-based compositions such as adhesives or pressure-sensitive adhesive tapes wherein a first irradiation step is utilized which involves electromagnetic radiation at relatively low average intensity (0, 1 to 20 mW/cm²) to effect a relatively low extent of monomer conversion (about 5% to 70%) followed by a subsequent step which employs electromagnetic radiation at relatively higher average intensity (greater than 20 mW/cm²) to complete the photopolymerization.

European Patent Application 0 319 155 A2 discloses a method for making high integrity composites, cellular adhesive membranes, which are made by first photopolymerizing a mixture of photopolymerizable monomers, and a photoinitiator, to provide a syrup with a viscosity of about 3000 cps. Additional photoinitiator and crosslinking agents plus any fillers and pigments, if desirable, are mixed into the syrup. The mixture is deaerated, and transferred to a frother at 300 rpm. Nitrogen, or another inert gas, is fed into the frother while a surfactant, if desired, is added. The frothed syrup is then transferred to a coater and coated between a pair of transparent, biaxially oriented polyethylene terephthalate films, the facing surfaces having low-adhesion coatings. The resultant foam is then irradiated with a bank of fluorescent black light bulbs having emissions primarily between 300 nm and 400 nm with a maximum at 351 nm, and exposure at 600 millijoules. The foam is kept below 85° C. to avoid wrinkling the film. The resulting cellular adhesive membrane is then cold roll laminated to a thermoplastic film which may have an acrylate pressure-sensitive adhesive thereon. This method results in a foam film having voids of at least 10% of the volume of the film distributed therein.

U.S. Pat. No. 5,902,836 issued to Bennett et al. on May 11, 1999 shows an acrylic syrup curable to a crosslinked viscoelastomeric material. The process for making a viscoelastic adhesive involves providing a composition of monomers mixed with an energy activated-initiator. The composition is exposed to energy so as to partially polymerize the monomer mixture to form a coatable adhesive syrup. The next step is to add some saturated energy-activated initiator, and some more monomers. The final step involves exposing the syrup to energy so that a viscoelastic adhesive is formed. An optional step involves coating the syrup on a substrate such as a flexible web.

PCT Application No. WO 95/29811 discloses a method of preparing a laminate that includes the steps of introducing first and second substrates each having first and second surfaces wherein both first surfaces are facing one another and one of the first surfaces has a polymerizable coating. A lamination bar is used to depress the two substrates together thus laminating the second substrate to the first. An example shows a polymerizable coating made of a mixture of 90% isooctylacrylate and 10% acrylic acid containing 0.04% photoinitiator. The monomers are partially polymerized, and no vacuum is utilized during the coating operation. The uncured laminate is passed under a bank of fluorescent black light lamps. A vacuum pull roll positioned at the end of the coating line is utilized to maintain a speed of 3.3 m/min. In most of the examples cited, the syrups are partially polymerized to viscosities of over 5000 cps.

None of the above inventions and patents, taken either singularly or in combination, is seen to describe the instant invention as claimed.

### SUMMARY OF THE INVENTION

The present invention is a pressure-sensitive adhesive tape having a compressible acrylic backing layer with hollow glass microspheres dispersed evenly throughout the backing and an adhesive layer disposed on at least one side of the backing, and to a method for making the pressure-sensitive adhesive tape which utilizes two opposing banks of ultraviolet lamps. A primer may be used to facilitate the adherence of the adhesive to the foam-like backing.

The object of the invention is to provide a compressible pressure-sensitive adhesive tape with a foam-like acrylic backing which can be used in place of conventional foam backed tapes, foam adhesives, or foam-like adhesives. The pressure-sensitive adhesive tapes of the current invention can be used wherever such tapes are used.

Another object of the current invention is to provide a compressible foam-like backing for a pressure-sensitive adhesive tape with increased strength compared to similar foam or foam-like tapes, and a lower density when compared to tapes with no foam or foam-like structure.

A further object of the invention is to provide a tape which recovers from compression. The present invention combines the advantages of the foam-like adhesives with the conventional foam backed tapes producing a strong pressure-sensitive adhesive tape having a substantial recovery from compression.

An object of the method for making the pressure-sensitive adhesive tapes according to the present invention is to increase the speed of the photopolymerization of the foam-like backing by providing two opposing banks of ultraviolet lighting to facilitate the polymerization of both sides of the backing concurrently. Furthermore, the two opposing banks result in the even polymerization of the polymer in the foam-like backing by promoting even light absorption of the photoinitiator(s).

A further object of the invention is to provide a foam-like backing which can be used with a variety of adhesives. A wide range of adhesives may be used with the present invention. The pressure-sensitive adhesive tapes may be customized according to their intended use.

These and other objects of the present invention will become readily apparent upon further review of the following specification.

### BRIEF DESCRIPTION OF THE DRAWINGS

The novel features of the described embodiments are specifically set forth in the appended claims; however, embodiments relating to the structure and process of making the present invention, may best be understood with reference to the following description and accompanying drawings.

FIG. 1 is a graph showing the percent recovery after compression of the foam-like backing according to the present invention.

FIG. 2 is a table showing the results of various tests performed on different embodiments of the pressure-sensitive adhesives according to the present invention.

### DETAILED DESCRIPTION OF THE PREFERRED EMBODIMENTS

The acrylic foam-like pressure-sensitive adhesive tape of the present invention contains: (a) a layer of an acrylic foam-like backing comprising (i) from about 88% to about 92% of an acrylic polymer containing: from about 35% to about 45% of a first alkyl acrylate monomer wherein the alkyl groups contain from 4 to 12 carbon atoms, from about 30% to about 40% of a second alkyl acrylate monomer wherein the alkyl groups contain from 4 to 12 carbon atoms, from about 6% to about 10% of a first monoethylenically unsaturated polar copolymerizable monomer, from about 1% to about 2% of a second monoethylenically unsaturated polar copolymerizable monomer, from about 0.3% to about 0.5% of photoinitiator, from about 1% to about 2% of a filler, from about 0.05% to about 0.07% of a crosslinker/chain extender, and (ii) from about 8% to about 12% of hollow glass microspheres dispersed evenly in the polymer; and (b) at least one layer of a pressure-sensitive adhesive. Each alkyl acrylate monomer is a monofunctional, unsaturated acrylate ester of a non-tertiary alkyl alcohol, the molecules of which have from about 4 to 12 carbon atoms.

As used herein, all percentages (%) are percent weight to weight, also expressed as weight/weight %, % (w/w), w/w, w/w % or simply %, unless otherwise indicated.

Included within the class of alkyl acrylate monomers are, for example, isooctylacrylate, isononylacrylate, 2-ethylhexyl acrylate, decylacrylate, dodecylacrylate, butylacrylate and hexylacrylate. The most preferred alkyl acrylate monomers are isooctylacrylate (available as Norsocryl®ioa from Elf Atochem® in France) as the first monomer and 2-ethylhexyl acrylate (available from LG Chem® in Korea) as the second monomer. Isononylacrylate can be substituted for isooctylacrylate, and butylacrylate, though less preferred, may also be substituted for isooctylacrylate.

The polar copolymerizable monomers can be selected from strongly polar monomers such as acrylic acid, itaconic acid, hydroxyalkyl acrylates, cyanoalkyl acrylates, acrylamides or substituted acrylamides, or from moderately polar monomers, though not preferred, such as N-vinyl pyrrolidone, N-vinyl caprolactam, acrylonitrile, and vinyl chloride. The most preferred copolymerizable monomers are acrylic acid (available from LG Chem in Korea) as the first monomer and acrylamide as the second monomer.

The proper photoinitiator or combination of photoinitiators is important for the overall process because photoinitiators absorb and utilize light energy to initiate photopolymerization. Suitable photoinitiators include those typically used in the polymerization of vinyl compounds. Other photoinitiators which may be substituted for the preferred benzoin ethyl ether (available from Seiko Chemical in Japan) include other acyloin ethers, such as benzoin isopropyl ether, anisoin ethyl ether, and anisoin isopropyl ether, and substituted acyloin ethers, alpha-hydroxymethyl benzoin ethyl ether. Using only one photoinitiator permits the wavelength of the ultraviolet source to be matched to the peak energy-absorbing wavelength of the photoinitiator. Long wavelength activatable photoinitiators allow UV radiation from UV lamps, having the long wavelength, to penetrate deeper in the coating materials, and is therefore suitable for a thicker adhesive coating. One or more photoinitiator may be used in the present invention.

A crosslinker/chain extending agent is used to increase the molecular weight of the polymer by increasing the length of the polymer chains, and to create a network of polymer chains crosslinked so as to decrease creep. The crosslinker/chain extending agent can be a multi-ethylenically unsaturated copolymerizable monomer containing at least two carbon-carbon double bonds. Such agents may include multifunctional acrylates which include, but are not limited to, ethylene glycol diacrylate, triethylene glycol diacrylate, 1,4-butanediol diacrylate, 1,6-hexanediol diacrylate, trimethylolpropane triacrylate, pentaerythritol triacrylate, and methacrylates thereof, and tetraethylene glycol diacrylate and its dimethacrylate (or demethacrylate). The preferred agent is 1,4-butanediol diacrylate available from Sartomer® in the United States as SR-213.

Fumed silica is utilized in the present invention as a filler to lower the density of the foam-like backing. It is noted that fumed silica is also a thixotropic agent which may be used to increase the viscosity of a mixture of monomers or oligomers. Fumed silica is available from Carbot® in the United States under the name M-5 Cab-O-Sil™. The average particle size is 0.2-0.3 microns. Other silicas may also be used, such as hydrophilic or hydrophobic group modified silicas which are referred to herein as surface modified silica.

Hollow glass microspheres such as borosilicate glass are used in the present invention to create discrete pockets of air. The borosilicate glass is available from Tokai Kogyo® in Japan as Z-27 Celstar®. The average particle size is 40-70 microns. These discrete pockets facilitate the ultraviolet polymerization of a thicker backing layer and aid in the compressibility and recovery of the resultant backing. No other voids are present in the backing layer of the present invention. Although voids may be present as an imperfection, in no circumstance are voids present in amounts as high as 15% by volume. High void content reduces the strength of the resulting pressure-sensitive adhesive tapes. The backing is a continuous, solid heteropolymer layer which contains hollow glass microspheres dispersed therein with no other voids.

In the preferred embodiment of the acrylic foam-like backing, the first alkyl acrylate monomer is isooctylacrylate, the second alkyl acrylate monomer is 2-ethylhexyl acrylate, the first monoethylenically unsaturated polar copolymerizable monomer is acrylic acid, the second monoethylenically unsaturated polar copolymerizable monomer is acrylamide, the photoinitiator is benzoin ethyl ether, the filler is fumed silica, the crosslinker/chain extender is 1,4 butanediol diacrylate, and the hollow glass microspheres are borosilicate glass. In the most preferred embodiment, the acrylic foam-like backing contains about 40.5±1% isooctylacrylate, about 36.5±1% 2-ethylhexyl acrylate, about 8.5±1% acrylic acid, about 1.5±1% acrylamide, about 0.40±0.01% benzoin ethyl ether, about 1.5±1% fumed silica, about 0.060±0.001% 1,4 butanediol diacrylate, and about 10.5±1% borosilicate glass.

The density of the foam-like backing may be controlled by varying the amount of silica gel and hollow glass microspheres mixed with the oligomer. A desirable density can be obtained without undue experimentation. Typically, the density is in the range of 700-900 kg/m³. The primer and the adhesives utilized are discussed below.

Furthermore, colorant, which is either dyes or pigments, may be present in sufficient quantities to depart color to the adhesive tape. Carbon black, for example, may be used to give the tape a darker appearance.

At least one adhesive layer is present on at least one surface of the foam-like backing. Suitable adhesive are preferably solution acrylic adhesives which include, but are not limited to, NSCC Duro-tak® 80-1105 LSE (National Starch and Chemical, United States), Gelva Multipolymer Solution 2933 or Gelva® Multipolymer Solution 2465 (Solutia Inc.), Duro-tak® 80-1077, 80-1093, 80-1099 and 80-1096 (National Starch and Chemical, United States), Aroset 1810, 1085, 280, 458, 390M, and 399 (Ashland Chemical, United States), and Gelva® Multipolymer Solutions 1753, 737 and 2659 (Solutia Inc.)

The method for making the pressure-sensitive adhesive tapes according to the present invention involves several steps. The first step is to prepare an oligomer composition from a monomer mixture while substantially excluding oxygen, and partially polymerizing the oligomer composition. The preferred method of excluding oxygen from the monomer mixture is by bubbling nitrogen therethrough.

The oligomer composition contains about 45% to about 55% of a first alkyl acrylate monomer wherein the alkyl groups contain from 4 to 12 carbon atoms, about 35% to about 45% of a second alkyl acrylate monomer wherein the alkyl groups contain from 4 to 12 carbon atoms, about 3% to about 4% of a first monoethylenically substituted monomer, and about 0.04% to about 0.06% of a photoinitiator. Preferably the oligomer composition contains 51±1% isooctylacrylate, 45±1% 2-ethylhexyl acrylate, 3.5±1% acrylic acid, and 0.04±0.01% benzoin ethyl ether.

In order to partially polymerize the monomer mixture to form an oligomer composition, it is preferred to extrude the monomer mixture through a 4″ diameter glass tube under ultraviolet radiation sufficient to initiate partial polymerization resulting in an oligomer having a viscosity of about 80 cps. The ultraviolet radiation is preferably generated by four ultraviolet lamps evenly surrounding the glass tubing. Preferably, the ultraviolet lamps, such as Model No. F40/BL (40W) available from Phillips®, have wavelength ranges from about 300 nm to about 400 nm peaking at about 356.0 nm with the majority of the ultraviolet light being in the wavelength of 356 nm to 365 nm. Alternative methods of polymerization, such as thermal polymerization, may be utilized to make the oligomer by mixing the monomers and a suitable initiator.

Next, a coating composition is formed by combining about 75% to about 80% by weight of the oligomer made in the first step, and a mixture having a first polar copolymerizable monoethylenically substituted monomer and a second polar copolymerizable monoethylenically substituted monomer having a combined weight percentage of about 6% to about 9%, about 0.3% to about 0.5% of at least one photoinitiator, about 1% to about 2% filler agent, about 0.05% to about 0.07% of a crosslinker/chain extender, and about 8% to about 12% hollow glass microspheres. If desirable, colorant may be added to the coating composition in order to depart color thereto.

Preferably, in the mixture added to the oligomer, the first polar copolymerizable monoethylenically substituted monomer is acrylic acid and the second polar copolymerizable monoethylenically substituted monomer is acrylamide, the photoinitiator is benzoin ethyl ether, the filler is fumed silica, the crosslinker/chain extender is 1,4 butanediol diacrylate, and the hollow glass microspheres are borosilicate glass. Most preferably, the mixture contains about 5.5% to about 6.5% acrylic acid, about 1% to about 2% acrylamide, about 0.35% to about 0.45% benzoin ethyl ether, about 1% to about 2% fumed silica, about 0.055% to about 0.065% 1,4 butanediol diacrylate, and about 10% to about 11% borosilicate glass wherein the borosilicate glass is from about 40 to about 70 microns.

It is preferable for the fumed silica to be added initially to the oligomer and mixed to disperse evenly therethrough. The fumed silica may be added the day before production. Once the fumed silica is dispersed the borosilicate glass, acrylic acid, and acrylamide are added and stirred until well dispersed. Last, the additional initiator and crosslinker/chain extender are added.

The coating composition is formed under a vacuum to the substantial exclusion of oxygen, and has a viscosity between 500 and 20,000 cps. The vacuum serves two purposes: it removes the air from the mixture and pulls voids out of the mixture. Substantially excluding oxygen by bubbling nitrogen through the mixture is preferable. It is not essential to have a completely inert atmosphere but it is preferable to limit oxygen to prevent retardation and premature termination of the polymerization reaction.

The oligomer composition may be prepared from the monomers by measuring out appropriate quantities of monomer and photoinitiator and placing in a mixing tank. The monomer is mixed in the mixing tank while nitrogen gas is discharged through a gas dispersion coil at the bottom of the tank. The monomer mixture is delivered via a metering pump at a predetermined flow rate to the bottom of a glass reactor. The monomer mixture travels from the bottom to the top of the glass reactor, and is partially polymerized by the four ultraviolet lamps. The resulting oligomer is discharged through an outlet at the top of the glass reactor into a storage tank. The remainder of the monomers, filler, initiator and hollow glass microspheres are added to the storage tank and mixed. The resulting coating composition may be initially blended with a propeller mixer and then blended with a homo-mixer to form a homogeneous mixture. The coating composition may be stored at this point. The coating composition is transferred to a feeding tank which utilizes a vacuum pump to remove the gas bubbles generated.

Subsequently, the coating composition is coated onto a first liner with a second liner contiguously covering the composition coated on the first liner to exclude air. The liners can be any appropriate films, such as polyester, polypropylene, polyethlene, polyethylene-polypropylene copolymer, polycarbonate, polyvinyl chloride, and the like, which are relatively transparent to UV radiation, preferably silicone coated polyester films. Most preferably, the liners are silicone coated polyethylene terephthalate liners. The thickness of the coating composition determines the thickness of the final foam-like backing.

Afterwards the composition is polymerized while sandwiched between the liners forming an essentially uniform foam-like sheet having hollow glass microspheres evenly distributed therethrough. Two banks of ultraviolet lights are utilized in the invention to polymerize the foam-like sheet as it passes between the two banks. Preferably, the heat generated by the photopolymerization process is cooled down using a jet of cold air from an air-conditioning nozzle or other comparable methods well known in the art. The ultraviolet lamps used have wavelength ranges from about 300 nm to about 400 nm peaking at about 356.0 nm with the majority of the ultraviolet light being in the wavelength of 356 nm to 365 nm. UV lamps having wavelengths complimentary to the wavelength of the photoinitiators utilized is desirable. For example, using long wavelength activatable photoinitiators with complimentarily long wavelength UV lamps permits thicker coatings to be utilized thereby permitting thicker tapes. The distance between the ultraviolet lamps and the foam surface in the preferred process is about 14.5 mm from the foam surface to the lower bank of lamps and about 17.0 mm from the foam surface to the upper bank of lamps. Preferably, each bank of lamps consists of 150 ultraviolet fluorescent lamps, such as Model No. F40/BL (40W) available from Phillips®.

A primer may be used to improve the adhesion of the pressure sensitive adhesive to one or two surfaces of the foam-like sheet. Suitable apparatuses for applying the primer to a surface of the foam-like sheet include, but are not limited to, mayer rod, kiss coater, reverse transfer roll, and gravure roll. The primers include but are not limited to, polyamide solution and emulsion, nitrile rubber based solution and emulsion, natural rubber based solution and emulsion, ethylene-propylene copolymer and ethylene-propylene-diene monomer terpolymer rubber based solution and emulsion, poly (ethylene-covinyl acetate solution and emulsion, poly(ethylene-co-vinyl acetate and alcohol) solution and emulsion, silane modified rubber and elastomer solutions. The primer is, preferably, composed of a mixture of 10% polyamide such as Macromelt 6238, 45% isopropyl alcohol, and 45% toluene. Any suitable primer may be utilized including grafted natural rubber such as Heveatex H1330 which is diluted to between 5 and 50%, preferably 20%, dispersion with the same amount of isopropyl alcohol and toluene as polyamide based primers. Tailoring the primer to the particular adhesive used is desirable thereby assuring that the layer of adhesive will not become separated from the foam-like backing during use. The primer coated foam-like sheet may be stored for later.

An appropriate pressure-sensitive adhesive is applied to the surface of the foam-like sheet with or without the primer thereon. Preferably, an acrylic adhesive is coated onto a release paper having silicone coated to both sides thereof, and the adhesive is cured in a conventional process. The adhesive is then laminated onto the surface of the foam-like sheet or the primer treated surface of the foam-like sheet while removing the liner of the foam-like sheet from that surface. Laminating pressures applied between the foam-like sheet and the adhesive is 3 to 5 kg/cm², typically 4 kg/cm². Preferably, both liners are removed from the foam-like sheet simultaneously. The paper liner may have a polyethylene release liner so that the paper liner is pealed off leaving the polyethylene release liner in place. Suitable adhesives are preferably solution acrylic adhesives which include, but are not limited to, NSCC Duro-tak® 80-1105 LSE (National Starch and Chemical, United States), Gelva Multipolymer Solution 2933 or Gelva® Multipolymer Solution 2465 (Solutia Inc.), Duro-tak® 80-1077, 80-1093, 80-1099 and 80-1096 (National Starch and Chemical, United States), Aroset 1810, 1085, 280, 458, 390M, and 399 (Ashland Chemical, United States), and Gelva® Multipolymer Solutions 1753, 737 and 2659 (Solutia Inc.)

### EXAMPLES

A foam-like backing was made according to the invention wherein 90.0 kg of an oligomer containing 184 kg of isooctylacrylate, 164 kg of 2-ethylhexyl acrylate, 12.7 kg of acrylic acid, and 0.185 kg of benzoin ethyl ether was mixed with 6.75 kg of acrylic acid, 1.5 kg of acrylamide, 0.07 kg of 1,4 butanediol diacrylate, 12.0 kg of borosilicate glass bubbles, 1.8 kg of fumed silica, and 0.4 kg of benzoin ethyl ether forming the coating composition.

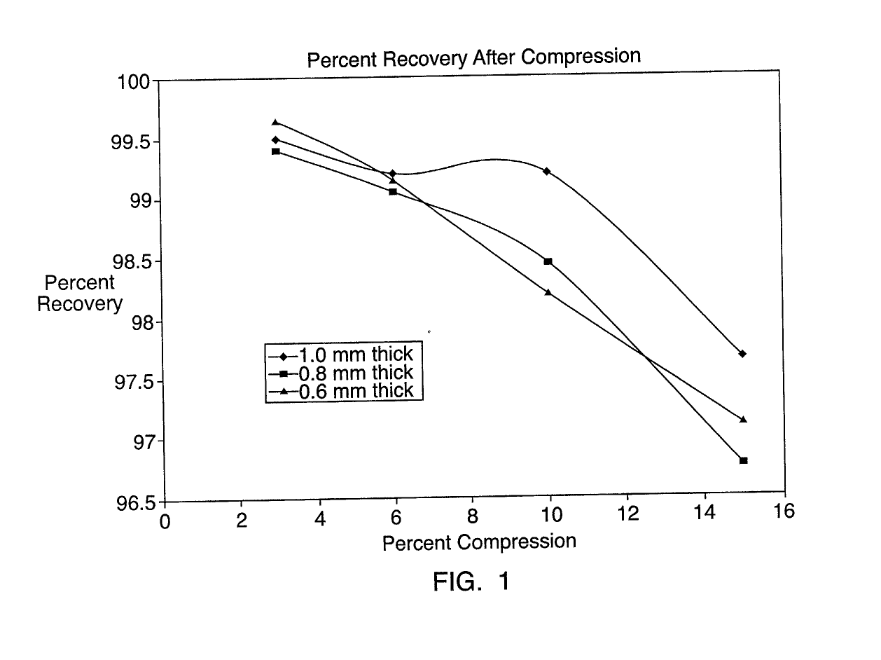

The percent recovery after compression at defined percentages for 30 seconds and allowing 60 seconds to recover were measured. Three foam-like backing thicknesses were measured: 1.0 mm, 0.8 mm and 0.6 mm. The results are shown in FIG. 1.

A surface analysis was performed on the foam-like backing via a scanning electron microscope analysis. No voids are evident in the majority of samples tested. Round open areas were found in the foam-like backing; however, these round open areas resulted from broken hollow microspheres, and not from gas bubbles in the coating composition.

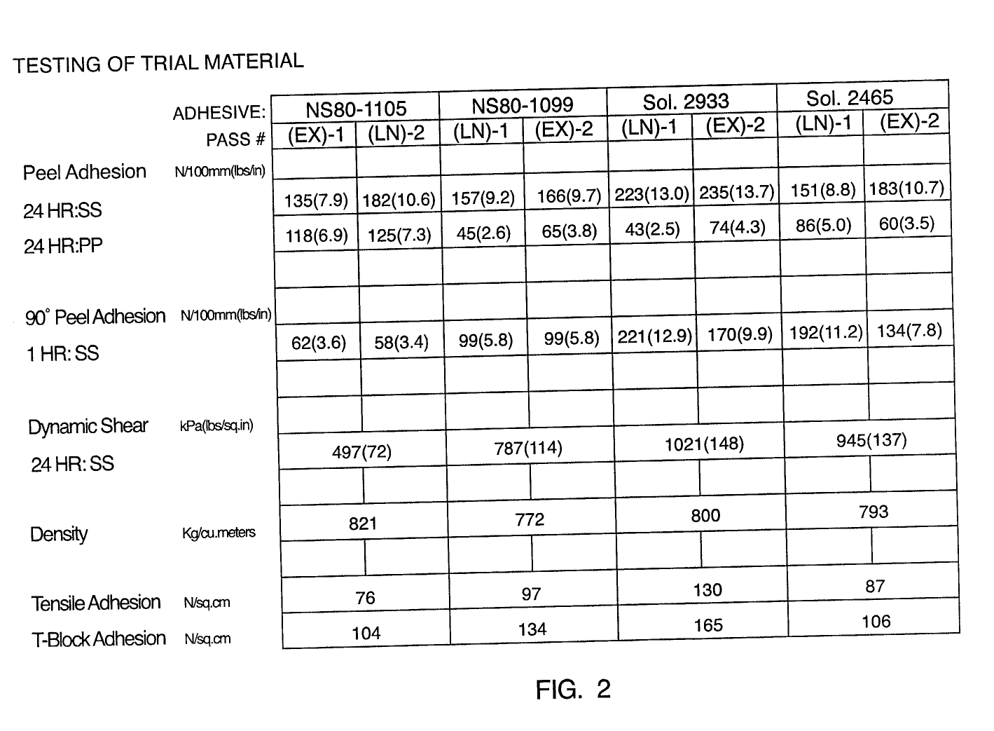

An acrylic solution adhesive, NS80-1105, was applied to both sides of a foam-like backing, made as above, forming a pressure-sensitive adhesive tape. White polycoated paper liner was used. A second pressure-sensitive adhesive tape was made as in the first example except that the adhesive NS80-1099 and a red polyethylene film liner were used. A third was made as in the second example except that the adhesive Solutia 2933 was used. A fourth pressure-sensitive adhesive tape was made as in the second example except Solutia 2465 was used. Testing data on these adhesive tapes is reported in FIG. 2.

The following tests have been used to evaluate the pressure-sensitive adhesive tapes of the present invention: peel adhesion, 90° peel adhesion, dynamic shear, density, tensile adhesion, and T-block adhesion. The test speed for the 180°/90° peel adhesion is 300 mm/min. The dynamic shear test was performed at 12.7 mm/min with 24.5 mm² having a 24 hour dwell with a 1 kg weight. The tensile adhesion was at 300 mm/min. The T-block adhesion was a 72 hour dwell at 300 mm/min.

It is to be understood that the present invention is not limited to the embodiments described above, but encompasses any and all embodiments within the scope of the following claims.

What is claimed is:

1. An acrylic foam-like pressure-sensitive adhesive tape comprising:
(a) a layer of an acrylic foam-like backing comprising
(i) from about 88% to about 92% of an acrylic polymer comprising:
from about 35% to about 45% of a first alkyl acrylate monomer having alkyl groups which contain from 4 to 12 carbon atoms,
from about 30% to about 40% of a second alkyl acrylate monomer having alkyl groups which contain from 4 to 12 carbon atoms,
from about 6% to about 10% of a first monoethylenically unsaturated polar copolymerizable monomer, and
from about 1% to about 2% of a second monoethylenically unsaturated polar copolymerizable monomer; and
(ii) from about 8% to about 12% of hollow glass microspheres dispersed evenly in said polymer; and
(b) at least one layer of a pressure-sensitive adhesive.

2. The acrylic foam-like pressure-sensitive adhesive tape according to claim 1, wherein the acrylic polymer includes from about 0.3% to about 0.5% of initiator.

3. The acrylic foam-like pressure-sensitive adhesive tape according to claim 2, wherein the initiator comprises at least one photoinitiator.

4. The acrylic foam-like pressure-sensitive adhesive tape according to claim 1, wherein the acrylic polymer includes from about 0.05% to about 0.07% of a crosslinker/chain extender.

5. The acrylic foam-like pressure-sensitive adhesive tape according to claim 4, wherein the crosslinker/chain extender is a multifunctional acrylate.

6. The acrylic foam-like pressure-sensitive adhesive tape according to claim 4, wherein the crosslinker/chain extender is a multi-ethylenically unsaturated copolymerizable monomer containing at least two carbon-carbon double bonds.

7. The acrylic foam-like pressure-sensitive adhesive tape according to claim 4, wherein:
the crosslinker/chain extender is taken from the group consisting of ethlene glycol diacrylate, triethylene glycol diacrylate, 1,4-butanediol diacrylate, 1,6-hexanediol diacrylate, trimethylolpropane triacrylate, pentaerythritol triacrylate, tetraethylene glycol diacrylate, and methacrylates and combinations thereof.

8. The acrylic foam-like pressure-sensitive adhesive tape according to claim 1, wherein the acrylic polymer includes from about 1% to about 2% of a filler.

9. The acrylic foam-like pressure-sensitive adhesive tape according to claim 8, wherein filler is a fumed silica.

10. The acrylic foam-like pressure-sensitive adhesive tape according to claim 8, wherein filler is a surface modified silica.

11. The acrylic foam-like pressure-sensitive adhesive tape according to claim 1, wherein:
the first alkyl acrylate monomer is isooctylacrylate,
the second alkyl acrylate monomer is 2-ethylhexyl acrylate,
the first monoethylenically unsaturated polar copolymerizable monomer is acrylic acid,
the second monoethylenically unsaturated polar copolymerizable monomer is acrylamide, and
the hollow glass microspheres are borosilicate glass.

12. The acrylic foam-like pressure-sensitive adhesive tape according to claim 11, wherein the acrylic polymer further comprises:
from about 0.3% to about 0.5% of initiator,
from about 1% to about 2% of a filler, and
from about 0.05% to about 0.07% of a crosslinker/chain extender.

13. The acrylic foam-like pressure-sensitive adhesive tape according to claim 12, wherein the initiator comprises at least one photoinitiator.

14. The acrylic foam-like pressure-sensitive adhesive tape according to claim 13, wherein the photoinitiator is benzoin ethyl ether.

15. The acrylic foam-like pressure-sensitive adhesive tape according to claim 11, wherein the filler is fumed silica.

16. The acrylic foam-like pressure-sensitive adhesive tape according to claim 11, wherein the filler is a surfaced modified silica.

17. The acrylic foam-like pressure-sensitive adhesive tape according to claim 11, wherein the crosslinker/chain extender is 1,4 butanediol diacrylate.

18. The acrylic foam-like pressure-sensitive adhesive tape according to claim 11, wherein the acrylic foam-like backing comprises:
from about 40% to about 41% isooctylacrylate;
from about 36% to about 37% 2-ethylhexyl acrylate;
from about 8% to about 9% acrylic acid;
from about 1% to about 2% acrylamide; and
from about 10% to about 11% borosilicate glass.

19. The acrylic foam-like pressure-sensitive adhesive tape according to claim 18, wherein the acrylic foam-like backing further comprises:
from about 0.35% to about 0.45% benzoin ethyl ether;
from about 1% to about 2% fumed silica; and
from about 0.055% to about 0.065% 1,4 butanediol diacrylate.

20. The acrylic foam-like pressure-sensitive adhesive tape according to claim 1, wherein the foam-like backing further comprises:
a sufficient amount of colorant to depart color to the adhesive tape.

21. A process for making a pressure-sensitive adhesive tape having an acrylic foam-like backing, the process comprising the steps of:
(1) preparing an oligomer while excluding oxygen and partially polymerizing the oligomer composition wherein the oligomer comprises from about 45% to about 55% of a first alkyl acrylate monomer having alkyl groups which contain from 4 to 12 carbon atoms, from about 35% to about 45% of a second alkyl acrylate monomer having alkyl groups which contain from 4 to 12 carbon atoms, from about 3% to about 4% of a first monoethylenically substituted monomer, and from about 0.04% to about 0.06% of at least one photoinitiator;
(2) forming a coating composition comprising from about 75% to about 80% by weight of said oligomer and a mixture having a first polar copolymerizable monoethylenically substituted monomer and a second polar copolymerizable monoethylenically substituted monomer having a combined weight percentage of from about 6% to about 9%, from about 0.3% to about 0.5% of at least one photoinitiator, from about 1% to about 2% filler, from about 0.05% to about 0.07% of a crosslinker/chain extender, and from about 8% to about 12% hollow glass microspheres, wherein, said coating composition is formed under a vacuum in the absence of oxygen and has a viscosity between 500 and 20,000 cps;
(3) coating the composition onto a first liner and having a second liner contiguously cover the composition on the first liner thereby excluding air;
(4) polymerizing the composition between the liners forming an essentially uniform foam-like sheet having glass microspheres evenly distributed therethrough; and
(5) coating at least one surface of the foam-like sheet with a pressure-sensitive adhesive.

22. The process of claim 21 wherein the step for coating at least one surface of the foam-like sheet with an appropriate pressure-sensitive adhesive comprises the steps of:
(1) applying a primer to at least one surface of the foam-like sheet;
(2) coating each surface having primer thereon with an appropriate pressure-sensitive adhesive.

23. The process of claim 21 wherein the step for coating at least one surface of the foam-like sheet with an appropriate pressure-sensitive adhesive comprises the steps of:
(1) applying a primer to one surface of the foam-like sheet;
(2) coating the surface having primer thereon with an appropriate pressure-sensitive adhesive; and
(3) coating the surface without primer thereon with an appropriate pressure-sensitive adhesive.

24. The process of claim 21 wherein the step for preparing the oligomer comprises the steps of:
(1) mixing about 51% isooctylacrylate, about 45% 2-ethylhexyl acrylate, about 3.5% acrylic acid, and about 0.04% benzoin ethyl ether
(2) excluding oxygen from the monomer mixture by bubbling nitrogen therethrough; and
(3) extruding monomer mixture through a 4″ diameter glass tube under ultraviolet radiation sufficient to initiate partial polymerization resulting in an oligomer having a viscosity of about 80 cps.

25. The process of claim 21 wherein:
the filler is fumed silica, the photoinitator is benzoin ethyl ether, and the cross linker/chain extender is 1,4 butanediol diacrylate.

26. The process of claim 21, wherein:
in the mixing step, the mixture having a first polar copolymerizable monoethylenically substituted monomer is acrylic acid and a second polar copolymerizable monoethylenically substituted monomer is acrylamide, the photoinitiator is benzoin ethyl ether, the filler is fumed silica, the crosslinker/chain extender is 1,4 butanediol diacrylate, and the hollow glass microspheres are borosilicate glass.

27. The process of claim 26, wherein the mixture comprises:
from about 5.5% to about 6.5% acrylic acid;
from about 1% to about 2% acrylamide;
from about 0.35% to about 0.45% benzoin ethyl ether;
from about 1% to about 2% fumed silica;
from about 0.055% to about 0.065% 1,4 butanediol diacrylate; and
from about 10% to about 11% borosilicate glass wherein the borosilicate glass is from about 40 to about 70 microns.

28. The process of claim 22, wherein the primer is composed of a mixture of polyamide, isopropyl alcohol and toluene.

29. The process of claim 28, wherein the primer is composed of a mixture of about 10±1% polyamide, about 45±1% isopropyl alcohol, and about 45±1% toluene.

30. The process of claim 22, wherein the primer includes polyamide solution and emulsion, nitrile rubber based solution and emulsion, natural rubber based solution and emulsion, ethylene-propylene copolymer and ethylene-propylene-diene monomer terpolymer rubber based solution and emulsion, poly (ethylene-co-vinyl acetate solution and emulsion, poly(ethylene-co-vinyl acetate and alcohol) solution and emulsion, silane modified rubber and elastomer solutions, and combinations thereof.

31. The process of claim 21, wherein the step for polymerizing the composition between the liners utilizes two opposing banks of ultraviolet lamps.

32. The process of claim 21, wherein the crosslinker/chain extender is taken from the group consisting of ethlene glycol diacrylate, triethylene glycol diacrylate, 1,4-butanediol diacrylate, 1,6-hexanediol diacrylate, trimethylolpropane triacrylate, pentaerythritol triacrylate, tetraethylene glycol diacrylate, and methacrylates and combinations thereof.

33. A process of making a pressure-sensitive adhesive tape having an acrylic foam-like backing, the method comprising the steps of:
(a) making an acrylic foam-like backing comprising the steps of
(1) preparing an oligomer composition which has a viscosity of about 80 cps by mixing the composition, bubbling an inert gas through the composition, and running the composition through a glass tube while exposing the oligomer to ultraviolet radiation wherein the oligomer composition consists essentially of about 51% isooctylacrylate, about 45% 2-ethylhexyl acrylate, about 3.5% acrylic acid, and about 0.04% benzoin ethyl ether;
(2) mixing 80% oligomer composition with about 6% acrylic acid, about 1.5% acrylamide, about 0.3% benzoin ethyl ether, about 1.6% fumed silica, about 0.06% 1,4 butanediol diacrylate; and about 10.5% borosilicate glass wherein the borosilicate glass is from about 40 to about 70 microns in a high speed mixer;
(3) excluding oxygen by bubbling an inert gas through the resultant mixture while pulling a vacuum sufficient to eliminate voids therethrough resulting a composition having a viscosity between 500 and 20,000 cps
(4) coating the composition at a rate of about 5 meters per minute onto a first liner having a second liner cover the composition on the first liner thereby excluding air; and
(5) exposing the composition on each side through the liners to ultraviolet radiation to polymerize the composition between the liners forming an essentially uniform foam-like sheet having glass microspheres evenly distributed therethrough; and
(6) coating at least one surface of the foam-like sheet with a pressure-sensitive adhesive.

34. The process of claim 33 wherein the step for coating at least one surface of the foam-like sheet with a pressure-sensitive adhesive comprises the steps of:
(1) applying a primer to at least one surface of the foam-like sheet;
(2) coating each surface having primer thereon with a pressure-sensitive adhesive.

35. The process of claim 33 wherein the step for coating at least one surface of the foam-like sheet with a pressure-sensitive adhesive comprises the steps of:
(1) applying a primer to one surface of the foam-like sheet;
(2) coating the surface having primer thereon with a pressure-sensitive adhesive; and
(3) coating the surface without primer thereon with a pressure-sensitive adhesive.

36. The process of claim 33, wherein the step of exposing the composition to ultraviolet light further consists of cooling the polymerized composition.

37. The process of claim 33, wherein the step for exposing the composition to ultraviolet light consists of pulling the coating composition and two liners between two opposing banks of ultraviolet light.

38. The process of claim 37, further comprising a step for cooling the composition between the liners as the polymerization step is being executed.

39. The process of claim 33, wherein the step for coating the adhesive comprises laminating the adhesive to at least one surface of the backing.

40. The process of claim 34, wherein the step for coating the adhesive comprises laminating the adhesive to the surface having primer thereon.
